(19) United States
(12) Patent Application Publication
(10) Pub. No.: US 2011/0063454 A1
(43) Pub. Date: Mar. 17, 2011

(54) Apparatus and method used to evaluate and optimize image quality in high color gamut imaging systems

(76) Inventor: Ferrand D E Corley, Mississauga (CA)

(21) Appl. No.: 12/923,332

(22) Filed: Sep. 15, 2010

Related U.S. Application Data
(60) Provisional application No. 61/272,366, filed on Sep. 17, 2009.

(51) Int. Cl. H04N 17/02; G09G 5/02

(52) U.S. Cl. 348/180; 345/590; 348/E17.004

(57) ABSTRACT

A test apparatus comprising a combination of front illuminated and rear illuminated optical reference test elements designed to produce predetermined electronic signals. The front illuminated elements comprise spectrophotometrically neutral gray patches and primary and secondary color patches of predetermined hues. Additional color patches having the same hue as the primaries and secondaries, but at lower saturation levels, generate unique logical patterns on display devices well known to the broadcasting and image reproducing industries. The rear illuminated test elements comprise wide color gamut hues at levels of saturation not attainable in reflected light systems. Also disclosed is a method of evaluating and optimizing the image quality in high gamut imaging systems, using the above described apparatus.

This application is based on U.S. provisional application 61/272,366, filed Sep. 17, 2009, Title; Apparatus and method used to evaluate and optimize image quality in high color gamut imaging systems

### FIELD OF THE INVENTION

The invention relates to a an apparatus and system and method for evaluating images and for optimizing image quality in High Colour Gamut Imaging Systems such as Colour Cameras.

### BACKGROUND OF THE INVENTION

Over the past 30 years the dynamic range of imaging systems has increased substantially; particularly in television and digital motion picture production. This is true both for image production, where cameras and memory devices record and store image data, and for playback systems such as television receivers, computer monitors and digital cinema projectors, which reproduce and display the image data for viewing. Early television cameras had a narrow, white to black, dynamic range of about 20:1; similarly color saturation was limited. Today, electronic cameras have a dynamic range of 3000:1 or higher and the color gamut of some cameras even exceeds that of human vision. This has resulted in challenges in the testing and alignment of such cameras, and the subsequent alignment and adjustment of image reproduction systems to provide faithful reproduction of images recorded by said cameras.

Traditional front lit test charts have the benefit of being easy to use, but inherently have a low dynamic range and low color saturation. Rear-lit test systems can have a higher dynamic range and greater color saturation, but are cumbersome and awkward to use.

### BRIEF SUMMARY OF THE INVENTION

This invention is designed to overcome these limitations by providing an apparatus designed for use in evaluating and adjusting the color and tonal reproduction of electronic imaging systems capable of recording and reproducing images of high dynamic range and extended color saturation. Said imaging systems include cameras, scanners, monitors, projectors and other devices used in the recording and reproduction of moving and still images.

The invention provides such an apparatus wherein a front illuminated precision grayscale with black and white reference patches and mid-saturation color patches also incorporates a rear illuminated light source capable of emitting colors of exceedingly high saturation close to or beyond that capable of being perceived by human vision.

The invention further provides such an apparatus where the three primary colors, red, green, and blue are combined in a single beam.

The invention further provides such an apparatus where the three primary colors may be turned on and off in sequence to produce six different highly saturated colors red, green, blue, cyan, magenta and yellow.

The invention further provides such an apparatus where the sequencing speed and order may be varied.

The invention further provides such an apparatus where the sequencing speed may be increased to the point where, due to the persistence of human vision, instead of seeing individual colors, the single rear illuminated area appears as white.

The invention further provides such an apparatus where by adjusting the brightness of each of the red, green and blue light channels individually, the color of the white light being emitted from the rear illuminated light source can be adjusted infinitely from 2500° Kelvin to 12,000° Kelvin

The invention further provides such an apparatus where the Kelvin temperature of light being emitted by the rear illuminated light source may be switchable and set to a number of standard color temperatures such as 3000, 3200, 5000, 5500, 6000 and 6500 K.

The invention further provides such an apparatus where separate cyan, magenta and yellow channels are added to the red, green and blue and, instead of being combined, emit their colors individually so that they may be seen simultaneously by a camera or other device viewing or recording the image produced by the apparatus.

The invention further provides such an apparatus where individual controls are provided for setting the brightness level of each color.

The invention further provides such an apparatus where light absorbing baffles help maintain maximum saturation in the rear illuminated colors by restricting light being used to illuminate the front-lit grayscale and color components from reaching the highly saturated elements.

The invention further provides such an apparatus wherein a space is provided between the light absorbing baffles and the diffuser, and including a black panel insertable into said space

The invention also provides a method of evaluating and adjusting the image quality of high colour gamut images and providing for viewing by such an imaging system a front illuminated precision grayscale with black and white reference patches and mid-saturation color patches and a rear illuminated light source capable of emitting colors of exceedingly high saturation close to or beyond that capable of being perceived by human vision.

### BRIEF DESCRIPTION OF THE DRAWINGS

The invention is described by way of illustration with reference to the accompanying drawings in which:

FIG. 1—Plan view of one embodiment of the apparatus in a typical operational environment;

FIG. 2—Side view of the apparatus;

FIG. 3—Front view of the apparatus;

FIG. 4—More detailed side view of the rear illuminated light source assembly;

FIG. 5—More detailed plan view of an alternative embodiment of the rear illuminated light source assembly, and,

FIG. 6—Is a plan view of a vector scope display.

### DESCRIPTION OF A PREFERRED EMBODIMENT

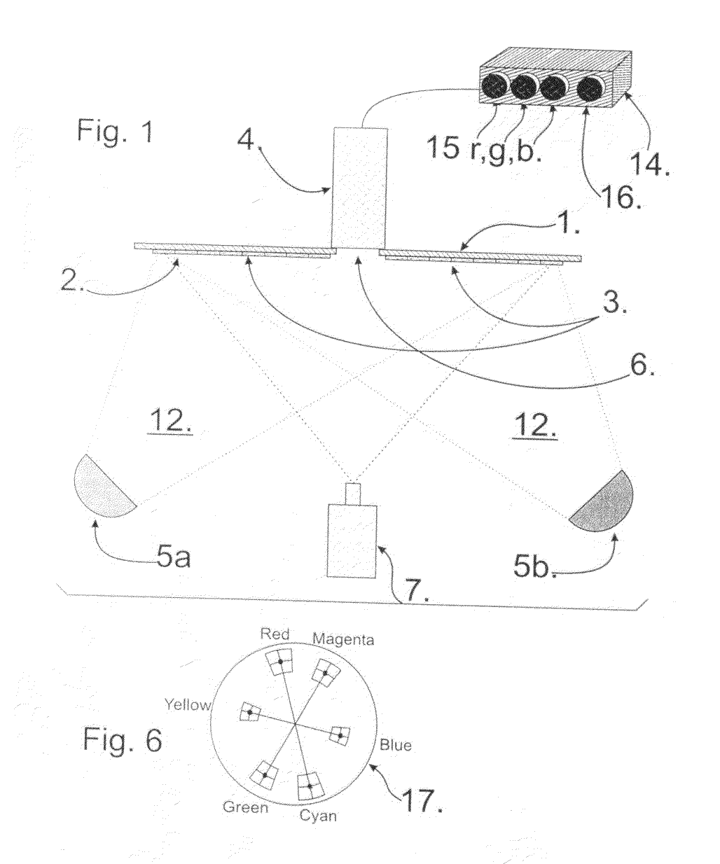

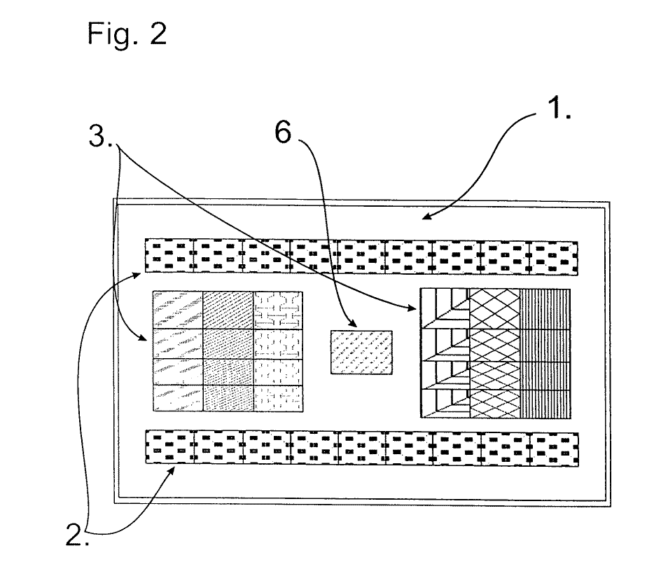

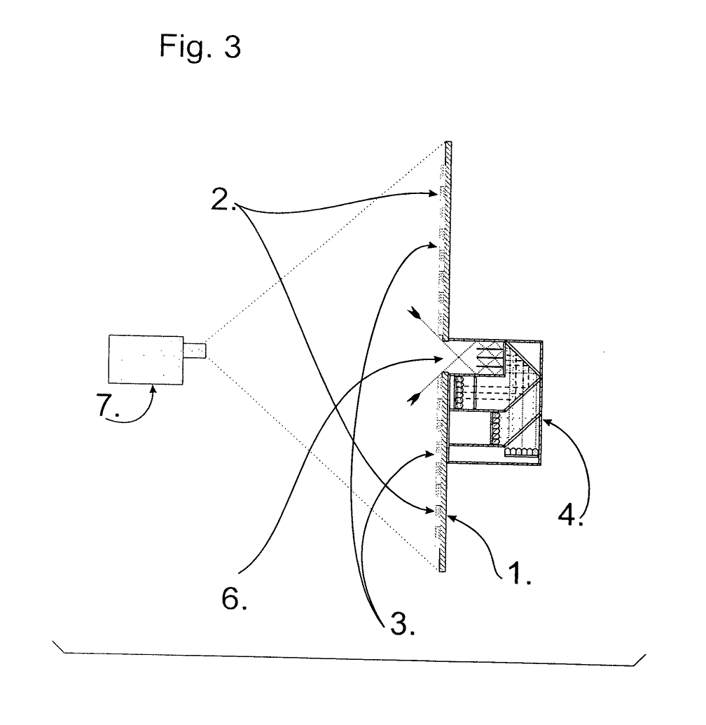

Referring to FIGS. 1-5, Grayscale (2) and color reference elements (3) are attached to a supporting member (1) and illuminated by light sources (5a) and (5b).

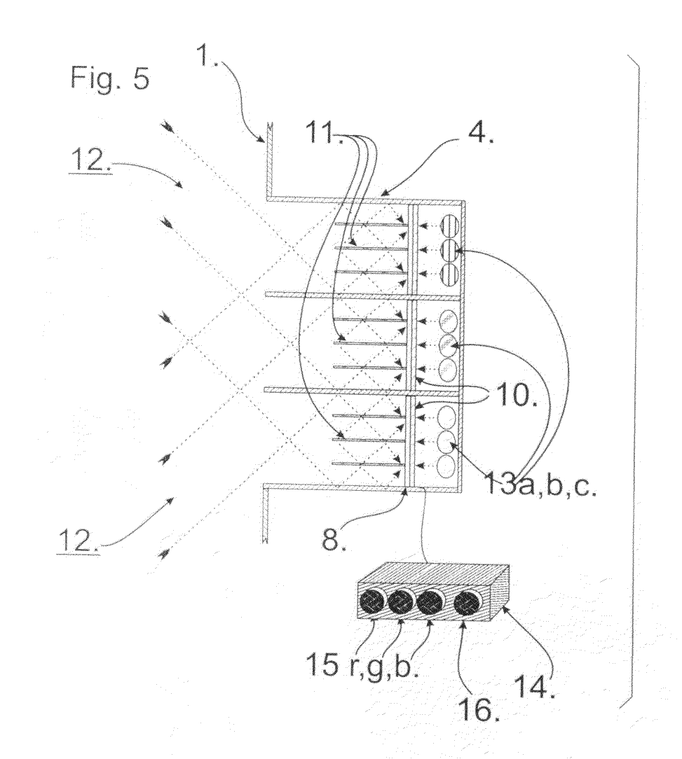

Light sources (5a & 5b) emit beams of illumination (12). Supporting member (1) is equipped with an aperture (6) behind which an illuminated light source assembly (4) is attached to said supporting member (1). Light source assembly (4) has illuminants (13) (FIG. 5) which generate colors having specific characteristics significantly more saturated than can be reproduced by light reflected from said color reference elements (3). The colors produced by light source assembly (4) are typically Red, Green, Blue, Cyan, Magenta and Yellow. An image recording device such as a camera (7) or scanner, records an image of precision grayscale (2) and color reference elements (3) along with the colors generated by light source assembly (4) and displays electronic signals generated by said camera (7) on a vectorscope (17) or other instrumentation known in the trade for reproducing grayscale and color data from digital images. This enables more detailed analysis of said color data than can be obtained from a visual representation of the image on a monitor or other projection device.

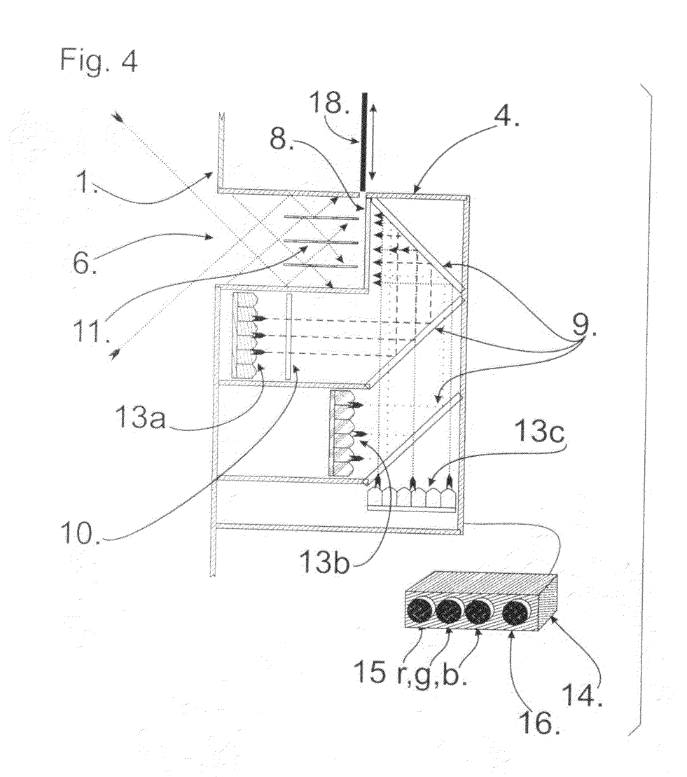

One or more diffusers (8) may be inserted in the light path within said light source assembly (4) to even the illumination from the rear illuminants (13 a, b, and c) (FIG. 5). Similarly, dichroic mirrors (9) (FIG. 4), and/or narrow band pass filters (10) may be inserted in the light source assembly (4) to narrow the spectral distribution of each light source. Light absorbing panels (11) (FIG. 4) are provided to trap front illumination (12) from light sources (5a and 5b) (FIG. 1), preventing said illumination (12) from being reflected by diffuser panel (8) which would reduce the saturation of colors from light source/s (13 a, b and c). Color controls (15 r, g, b) control the mix and intensity of light sources (13) to obtain the highly saturated colors generated and emitted by light source assembly (4).

Color controls (15 r,g,b) in control unit (14) enable precise adjustment of the mix and intensity of said light sources (13) to obtain the highly saturated colors generated and emitted by light source assembly (4).

Switching speed control (16) adjusts the duration that light sources (13) remain illuminated. The typical switching sequence is 1) (13a)=Red, 2) (13a+c) (Red+Blue)=Magenta, 3) (13c)=Blue, 4) (13 c+b) (Blue+Green)=Cyan, 5) (13b)=Green and 6) (13a+b) (Green+Red)=Yellow, then the sequence starts over again.

With the speed control set to Low, each color, or color pair, stays on for one second; by increasing the cycling speed the rapidly changing colors will, through perception of human vision, appear to be white.

Color controls (15) can then be finely adjusted so that the “white” being produced by light sources (13) matches the white patches on the grayscale being illuminated by external light sources (5a and 5b). Depending on the application this will typically be 3200K, D50, or D65

However, the individual colors generated by light sources (13) will still reproduce as individual color signals on the vectorscope (17) (FIG. 6).

Further embodiments may include;

a—In the embodiment of FIG. 5, three or more individual rear illuminants (13) a,b,c in light source assembly (4) shine individually through separate apertures in supporting member (1). This requires that the rear illuminants (13) serving each aperture be unique to that band pass filter (10), and similarly that they have separate light absorbing panels (11), diffusers (8) and narrow band pass filters (10).

This can be a benefit in systems where it might be difficult to synchronize the switching speeds of the rear illuminants with that of the camera operating at a certain frame rate, such as those used in high speed photography.

b—In another embodiment light source assembly (4) uses a single light source (13) with six primary narrow bandpass color filters (10) assembled and rotating on a disk. The brightness of the individual colors and the overall color balance of the white light being produced by the rapidly changing filters is adjusted using neutral density filters positioned with each narrow bandpass color filter.
c—As in embodiment (b), but using a Ferris wheel assembly to hold the filters. A polarizing filter located behind the diffusers enables the brightness of the individual colors to be controlled by rotating separate polarizing filters in front of each of the six primary narrow bandpass color filters (10).

The foregoing are descriptions of preferred embodiments of the invention which are given here by way of example only. The invention is not to be taken as limited to any of the specific features as described, but comprehends all such variations thereof as come within the appended claims.

What is claimed is:

1. An apparatus for use in evaluating and adjusting the color and tonal reproduction of electronic imaging systems wherein a front illuminated precision grayscale with black and white reference patches and mid-saturation color patches also incorporates a rear illuminated light source capable of emitting colors of exceedingly high saturation close to or beyond that capable of being perceived by human vision.

2. An apparatus for use in evaluating and adjusting the color and tonal reproduction of electronic imaging systems as claimed in claim 1, but where the three primary colors, red, green, and blue are combined in a single beam.

3. An apparatus for use in evaluating and adjusting the color and tonal reproduction of electronic imaging systems as claimed in claim 2 but where the three primary colors may be turned on and off in sequence to produce six different highly saturated colors red, green, blue, cyan, magenta and yellow.

4. An apparatus for use in evaluating and adjusting the color and tonal reproduction of electronic imaging systems as claimed in claim 3, but where the sequencing speed and order may be varied.

5. An apparatus for use in evaluating and adjusting the color and tonal reproduction of electronic imaging systems as claimed in claim 4, but where the sequencing speed may be increased to the point where, due to the persistence of human vision, instead of seeing individual colors, the single rear illuminated area appears as white.

6. An apparatus for use in evaluating and adjusting the color and tonal reproduction of electronic imaging systems as claimed in claim 5, but where by adjusting the brightness of each of the red, green and blue light channels individually, the color of the white light being emitted from the rear illuminated light source can be adjusted infinitely from 2500° Kelvin to 12,000° Kelvin

7. An apparatus for use in evaluating and adjusting the color and tonal reproduction of electronic imaging systems as claimed in claim 6, but where the Kelvin temperature of light being emitted by the rear illuminated light source may be switchable and set to a number of standard color temperatures such as 3000, 3200, 5000, 5500, 6000 and 6500 K.

8. An apparatus for use in evaluating and adjusting the color and tonal reproduction of electronic imaging systems as claimed in claim 2, but where separate cyan, magenta and yellow channels are added to the red, green and blue and, instead of being combined, emit their colors individually so that they may be seen simultaneously by a camera or other device viewing or recording the image produced by the apparatus.

9. An apparatus for use in evaluating and adjusting the color and tonal reproduction of electronic imaging systems as claimed in claim 8, but where individual controls are provided for setting the brightness level of each color.

10. An apparatus for use in evaluating and adjusting the color and tonal reproduction of electronic imaging systems as claimed in claim 2, but where light absorbing baffles help maintain maximum saturation in the rear illuminated colors by restricting light being used to illuminate the front-lit grayscale and color components from reaching the highly saturated elements.

11. An apparatus for use in evaluating and adjusting the color and tonal reproduction of electronic imaging systems as claimed in claim 10 wherein a space is provided between the light absorbing baffles and the diffuser, and including a black panel insertable into said space

12. A method of evaluating and adjusting the image quality of high colour gamut images and providing for viewing by such an imaging system a front illuminated precision grayscale with black and white reference patches and mid-saturation color patches and a rear illuminated light source capable of emitting colors of exceedingly high saturation close to or beyond that capable of being perceived by human vision.

13. The method as claimed in claim 12 and wherein the three primary colors, red, green, and blue are combined in a single beam.

14. The method as claimed in claim 12 wherein the three primary colors may be turned on and off in sequence to produce six different highly saturated colors red, green, blue, cyan, magenta and yellow.

15. The method as claimed in claim 14 including the step of varying the sequencing speed and order of turning on and off.

16. The method as claimed in claim 12 including the step of adjusting the brightness of each of the red, green and blue light channels individually, whereby the color of the white light being emitted from the rear illuminated light source can be adjusted infinitely from 2500° Kelvin to 12,000° Kelvin.

17. The method as claimed in claim 12 including the step of establishing separate cyan, magenta and yellow channels and adding them to the red, green and blue and, emit their colors individually so that they may be seen simultaneously by a camera or other device viewing or recording the image produced by the apparatus.

18. The method as claimed in claim 12 including the step of providing a space d between the light absorbing baffles and the diffuser, and inserting a black panel into said space
